(19) United States
(12) Patent Application Publication
(10) Pub. No.: US 2014/0126373 A1
(43) Pub. Date: May 8, 2014

(54) DYNAMIC TRAFFIC OFFLOADING

(71) Applicants: Yinghua Ye, Santa Clara, CA (US); Ram Gopal Lakshmi Narayanan, Sunnyvale, CA (US)

(72) Inventors: Yinghua Ye, Santa Clara, CA (US); Ram Gopal Lakshmi Narayanan, Sunnyvale, CA (US)

(73) Assignee: NOKIA SIEMENS NETWORKS OY, Espoo (FI)

(21) Appl. No.: 14/125,350

(22) PCT Filed: Jun. 16, 2011
(86) PCT No.: PCT/US2011/040659

§ 371 Date: Dec. 11, 2013

(51) Int. Cl. H04W 28/02; H04W 24/00

(52) U.S. Cl. CPC H04W 28/0247; H04W 24/00
USPC 370/235; 370/242; 370/244

(57) ABSTRACT

Data services may be enhanced by mitigating the need for unplanned core network capacity expansion or network element upgrades and reconfiguration, by offloading data to an alternative network, such as Exchange Point (IXP) or other operator network. A method can include monitoring a status of a transit network. The method can also include offloading traffic to the transit network from a transport network when a predetermined condition is met. The predetermined condition includes the status of the transit network indicating that the transit network is operational.

### BACKGROUND

1. Field

Data services may be enhanced by mitigating the need for unplanned core network capacity expansion or network element upgrades and reconfiguration, by offloading data to an alternative network, such as Exchange Point (IXP) or other operator network.

Several architecture solutions for Selected IP Traffic Offloading (SIPTO)/Local IP Access (LIPA) can be employed. For SIPTO, operators may be allowed to offload some data traffic at either RNC or above in a third generation network, base station in the case of long term evolution (LTE) network or deploying gateway close to users.

2. Description of the Related Art

Even in conventional approaches to a place where offload traffic is placed and what type of traffic needs to be offloaded, it is assumed that the network to which that traffic is offloaded is reliable. The decision to offload data packets may be based on policy information provided or other subscriber related information provided by a mobile operator.

The user's traffic for offloading in such approaches are destined to non-operator hosted services, and such traffic includes best-effort type that the user is not really interested in QoS treatment. If the offloaded-to network fails to provide connectivity for these packets, the mobile network infrastructure may be unable to detect the failure, and may continue to offload traffic. After offloading the traffic to the transit or temporary network, there is conventionally no feedback mechanism for the hosted wireless operator to make possible alternate decision in case of transit network outages.

### SUMMARY

According to certain embodiments, a method includes monitoring a status of a transit network. The method also includes offloading traffic to the transit network from a transport network when a predetermined condition is met. The predetermined condition includes the status of the transit network indicating that the transit network is operational.

An apparatus, according to certain embodiments, includes at least one memory comprising computer program instructions and at least one processor. The at least one memory and the computer program instructions are configured to, with the at least one processor, cause the apparatus at least to monitor a status of a transit network. The at least one memory and the computer program instructions are also configured to, with the at least one processor, cause the apparatus at least to offload traffic to the transit network from a transport network when a predetermined condition is met. The predetermined condition includes the status of the transit network indicating that the transit network is operational.

A computer readable non-transitory medium, according to certain embodiments, is encoded with a computer program containing instructions that, when executed in hardware, perform a process. The process includes monitoring a status of a transit network. The process also includes offloading traffic to the transit network from a transport network when a predetermined condition is met. The predetermined condition includes the status of the transit network indicating that the transit network is operational.

According to certain embodiments, an apparatus can include monitoring means for monitoring a status of a transit network. The apparatus can also include offloading means for offloading traffic to the transit network from a transport network when a predetermined condition is met. The predetermined condition includes the status of the transit network indicating that the transit network is operational.

### BRIEF DESCRIPTION OF THE DRAWINGS

For proper understanding of the invention, reference should be made to the accompanying drawings, wherein:

FIG. 1 illustrates a dynamic offloading architecture based on network traffic according to certain embodiments.

FIG. 2 illustrates internal modules related to local breakout from a local gateway according to certain embodiments.

FIG. 3 illustrates implementation examples according to certain embodiments of the present invention.

FIG. 4 illustrates additional implementation examples according to certain embodiments of the present invention.

FIG. 5 illustrates a method according to certain embodiments of the present invention.

FIG. 6 illustrates a system according to certain embodiments of the present invention.

### DETAILED DESCRIPTION OF THE PREFERRED EMBODIMENT(S)

As mentioned above, data services may be enhanced by lessening or avoiding the need for unplanned core network capacity expansion, or network element upgrades and reconfiguration, by offloading data to an alternative network, such as Exchange Point (IXP) or other operator network. This offloaded-to network or transit network can, therefore, provide greater flexibility to a core network operator.

Selected IP Traffic Offloading (SIPTO)/Local IP Access (LIPA) represent some approaches that can be used. For SIPTO, operators may be allowed to offload some data traffic at either a radio network controller (RNC) or above in a third generation network, base station in the case of long term evolution (LTE) network or a gateway deployed close to users.

If operators of communication systems solely rely on policies defined in a policy and charging rules function (PRCF—also known as a policy server) to decide what to offload from their mobile network to an offloaded-to network (also called a transit network), such policies are static and may be very simple Thus, the traffic may be blindly offloaded to the transit network without knowledge of the network dynamics of the offloaded network. Hence, the only packet sessions to be selected as offload candidate are those containing bulky data that has less value for operators.

Certain embodiments of the present invention provide for how and when to divert to an offload network. Thus certain embodiments provide and implement the dynamics of offload decisions to process and provide reliable packet transport.

Additionally, certain embodiments provide for and implement detection of failure in the offload network for a local gateway (LGW), the breakout network element in mobile network. If failure is detected, certain embodiments address how the LGW reacts, so as to avoid further packet losses.

Furthermore, certain embodiments of the present invention relate to how to enable the offloaded network to provide reliable connectivity for operators services. Likewise, certain embodiments of the present invention relate to how to meter and monitor the traffic, as well has to identify trends and take those results as the inputs for further network planning.

Certain embodiments, therefore, use (for example) multi-protocol label switching (MPLS) to set up virtual link between a local gateway and a packet data network (PDN) gateway (PGW). MPLS is one of the ways to achieve this, but there are other possibilities to have a separate virtual local area network (VLAN) in the core network to allow operators to offload traffic destined to their own services. The virtual link can be set up within the offloaded-to network.

Moreover, certain embodiments leverage the established virtual link to measure the health status of the external network, as well as to enable operators to have some visibility as to the health status of the external network (offloaded-to network), and to make decisions as to whether to offload traffic or to set an amount of offload traffic.

Certain embodiments provide a new input interface for an offload decision module to add consideration of the health status of the external network as a factor in offload decisions.

Moreover, certain embodiments provide a feedback mechanism on offloaded network for offloading decision process, thus the operator can update their offload policy on the fly based on the network status of the offloaded network.

Thus, a virtual link can be established between a local gateway and a packet data network gateway through an external offloaded-to network. This virtual link can be leveraged, specifically as to its built-in reliability mechanism, so that the local gateway can break out interface information to detect potential failure in the offloaded-to network. By monitoring the health status of such virtual link, the operator may be able to dynamically offload traffic. Further this approach may also enable the operator to offload traffic destined to the operator's own services, including those that require guaranteed connectivity.

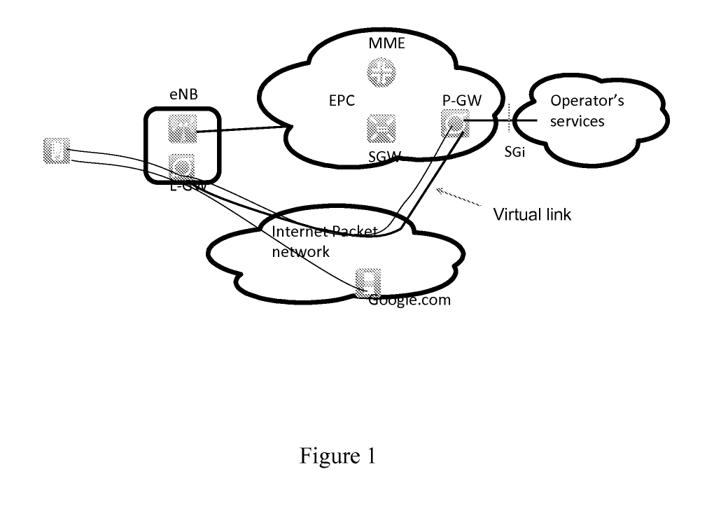

Typically, a packet data network (PDN) gateway (PGW) can provide connectivity from a user equipment (UE), such a mobile phone, personal digital assistant, or other terminal or communication device, to external packet data networks including operator services and Internet by being the point of exit and entry of traffic for the user equipment, as shown in FIG. 1. A local breakout at the base station is just an example. The packet data network gateway may be a core network component that connects to operator services through the SGi interface (Gi is a term for an internet protocol (IP) based interface to a public data network either directly or through a gateway), and the packet data network gateway may be within the operator's domain.

In order to accomplish such functionality, the packet data network gateway can be provided with an interface that obtains an IP address from one or more external packet networks. Such an interface can permit a user equipment to access operator services without going through the evolved packet system (EPS). One reason to use the packet data network gateway as an entry point to/from an external network is that the packet data network gateway can perform policy enforcement, packet filtering for each user, charging support, lawful interception and packet screening Additionally, the packet data network can serve as an anchor point to provide mobility between third generation partnership project (3GPP) and non-3GPP technologies. Thus, the packet data network gateway may have control over who can access an operator's services.

Since the local gateway and the packet data network gateway can be under the same operator, they can be configured to know one another's IP address, which can be reached through external Internet packet networks. The virtual link between the local gateway and the packet data network gateway can be setup by leveraging multiprotocol label switching Multiprotocol label switching can be used, for example, in Internet packet network. label distribution protocol (LDP) and resource reservation protocol (RSVP) traffic engineering (RSVP-TE), an extension of RSVP for traffic engineering, which can be used for setting up and maintaining a virtual circuit.

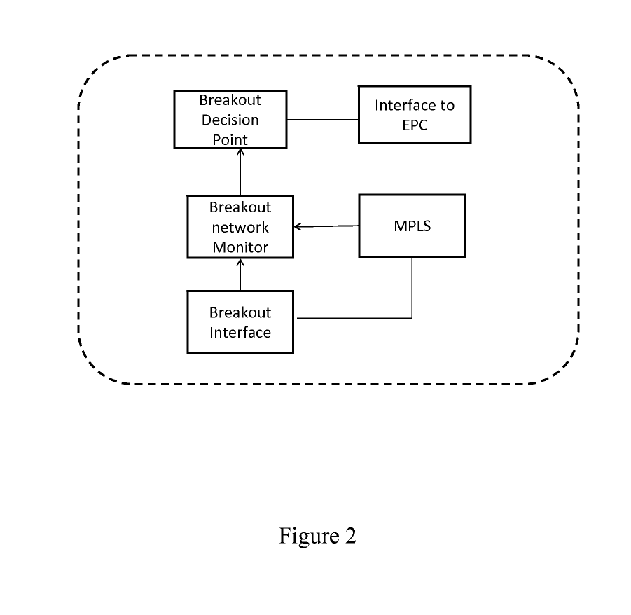

A breakout network monitor and policy module can reside in a local gateway, as shown in FIG. 2. The external network status can be collected through monitoring local breakout interface and multiprotocol label switching module at the local gateway, and such information can be provided to the policy decision point module as an input for making breakout decisions.

Certain embodiments of the present invention provide for two scenarios (1) when an external network is normal; and (2) breakout with respect to a congested/failed external network.

The normal external network scenario can refer to a situation in which the external network is functional, and not congested. Due to the setup of a virtual circuit from a local gateway to a packet data network gateway, the operator services can be reached through the external network reliably. This reliability can be assured because multiprotocol label switching has a built-in connectivity maintenance mechanism. Thus, the traffic offload may not be limited to Internet offload: the packets designated for operator services can also be offloaded.

The offloading packet process can proceed in the following way, as one example. First, during user equipment attachment, the policy decision point can obtain the offloading related policy from the policy charging and rules function (PCRF) through a Gi interface. Alternatively, the policy can be obtained from an access network discover and selection function (ANDSF). The policy can be application type, destination address, port number, and so forth.

Next, when the packets from the user equipment arrive at the local gateway, the policy decision point module can enforce the relevant policy related to a specific user equipment to decide where the packets will be sent. Then, if the packets are not allowed to have breakout, they can be sent to the evolved packet core (EPC) interface, which connects to an evolved packet core network. Moreover, if packets are destined to operator services and allowed to have breakout, they can be sent to a multiprotocol label switching enabled virtual circuit, and subsequently (after bypassing a transport network) they can be provided to the operator services network (for example, the core network). Furthermore, if packets have a destination other than the operator service networks, they can be sent out to an external network through local breakout interface directly.

When, on the other hand, the external network is congested or failed, there are many ways that a policy decision point can utilize the error input from breakout network monitor module. For example, the breakout network monitor (BNM) module can discover the unexpected packet losses from either a local breakout interface or a multiprotocol label switching module. Then, when such losses are discovered, the breakout function can be disabled at the policy decision point. Thus, for example, the existing breakout connections can be stopped and all packets can be sent through the evolved packet core. Once the breakout network monitor module detects that the external network is back to normal operational mode, the breakout feature can be enabled (or re-enabled). Previous breakout connections can be restored, and newly admitted connections that qualify under the breakout policy can be broken out to the external network.

Another use case is when the breakout network monitor module monitors the delay of packets on virtual circuit and delay happens to exceed a certain threshold. The threshold can be preset by the operator through an operation, administration, and maintenance (OAM) system. The breakout network monitor module can be triggered by the excess delay to send the policy decision module the delay related information. Then, the policy decision module can disable the breakout capability for new connections. Once the breakout network monitor module detects that the packet delay over the virtual circuit has been reduced to satisfy the threshold condition, the breakout network monitor module can update the policy decision module to enable breakout function for new connections. Meanwhile, the existing connections can still go through the evolved packet core, even though they may qualify for breakout in terms of policy. Alternatively, as noted above, previous breakout connections can be restored. Which alternative is employed may be determined by an operator.

Various embodiments of the present invention may have advantages. For example, certain embodiments can incorporate the offload network health status of an offload network into a breakout process can enable dynamic network offload. Thus, certain embodiments can provide a reliable offload solution.

Additionally, certain embodiments can ensure user equipment connectivity in an offload-enabled network. Moreover, certain embodiments can enable a user equipment to access an operator's services through an offloaded-to network.

Certain embodiments of the present invention can be implemented without modification to the user equipment and can support all kinds of user equipment devices, including legacy devices. Thus, certain embodiments may be able to be easily integrated into various networks and can benefit the mobile communications operators.

Based on the heath status of an offloaded-to/transit network, the offload decision entity can, in certain embodiments, decide on the fly whether to reduce or increase the number of offloading sessions. For example, if the offloaded-to network is congested, then few sessions can be offloaded. In an extreme case where the offloaded network is broken, then all the traffic can go through the evolved packet core. In certain embodiments, the parameters for monitoring and metering can be configurable.

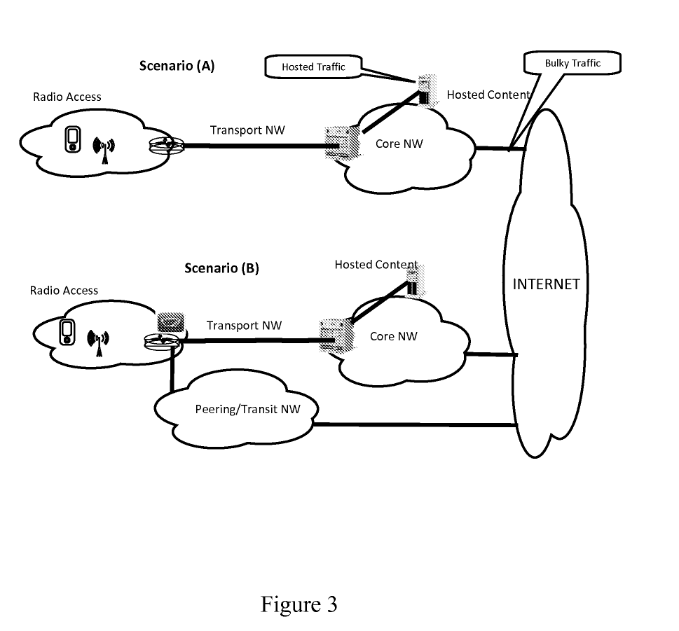

FIG. 3 illustrates implementation examples according to certain embodiments of the present invention. As shown in scenario (A) in FIG. 3, both bulky traffic (non-operator hosted services) and hosted traffic can be passed within an operator network. Thus, the radio access network can carry all of the traffic to the core network, at which point the hosted traffic can be suitably diverted to the hosted content and the bulk traffic can continue on to the Internet (or another external network). This approach may be used when an offloaded-to network is unavailable or is has been deemed to have “failed” in terms of a criterion such as a latency threshold.

In a second scenario, (B) in FIG. 3, the transport network may seem to be overloaded and consequently bulk traffic may be offloaded to proceed toward the Internet via a transit network. This transit network or “peering” network may not be operated by the operator of the transport and/or core network. This approach may be used when the offloaded-to network meets some minimum performance criterion or is simply known to be operating generally correctly. Metering and/or monitoring of the offloaded-to network and traffic thereto (or therefrom) may be performed at the offload network element, such as a local gateway, inside the radio access network. The hosted traffic may be permitted to proceed through the transport network to the core network and from there to the hosted content.

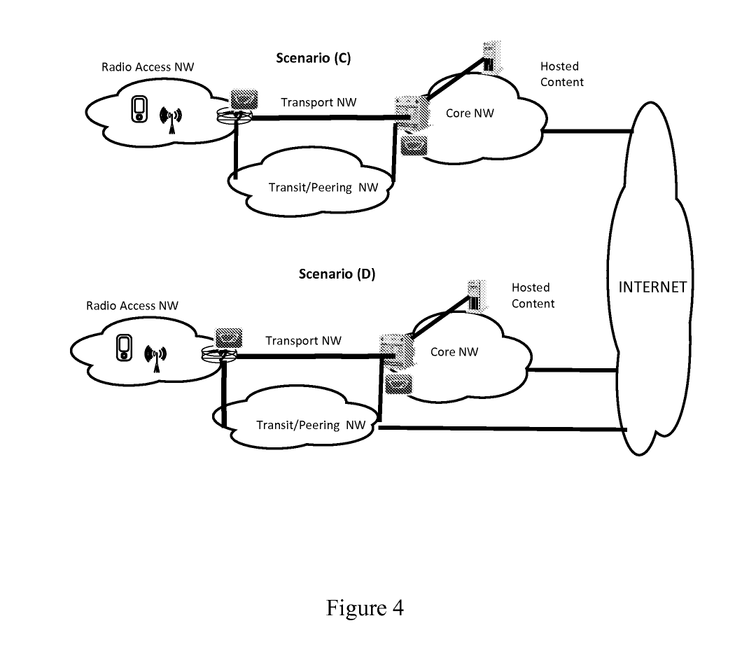

FIG. 4 illustrates additional implementation examples according to certain embodiments of the present invention. Scenario (C), as shown in FIG. 4, is a situation in which the downlink may be overloaded in the transport network. Thus, part of the downlink traffic can be routed from the core network to the access network via a transit network. Metering and/or monitoring can be performed in the core network. Of course, while downlink is shown, analogously uplink traffic or both uplink and downlink traffic could be similarly routed.

FIG. 4 also illustrates scenario (D), in which a network is overloaded both for bulky traffic and hosted traffic. In such a situation, both bulky traffic and hosted traffic can be offloaded. The hosted traffic can be re-directed back to the core network after bypassing the transport network, whereas the bulky traffic can proceed to the Internet or another public network. Monitoring and metering can be done

The downlink packets can be variously routed, as can be seen from the above examples. The offloading can be flow or session based, and can be performed differently depending on whether network address translation (NAT) is used.

When network address translation is used, the downlink packets addressed or otherwise destined to a specific user equipment can have two source IP addresses at the packet data network gateway: for the sessions/flows going through operator transport network, the downlink packets for such sessions/flows can have the user equipment's IP address, these packets can be routed to the user equipment through the operator's network; and for the sessions/flows going through transit network, the downlink packets have a network address translation address, and can be routed to the user equipment via a transit network.

When no network address translation is used, traffic engineering can come into play, as the packet data network gateway can be configured to identify flow/session based on source IP/port, destination IP/port, and route sessions differently.

In some eNBs, such as an LTE-Flexi Base Station, the eNB may support two separated interfaces, in which the two logical links do not share the same physical connections. Furthermore, the offloading does not have to occur at the eNB, it can occur at or above a radio network controller (RNC) in a third generation (3G) network.

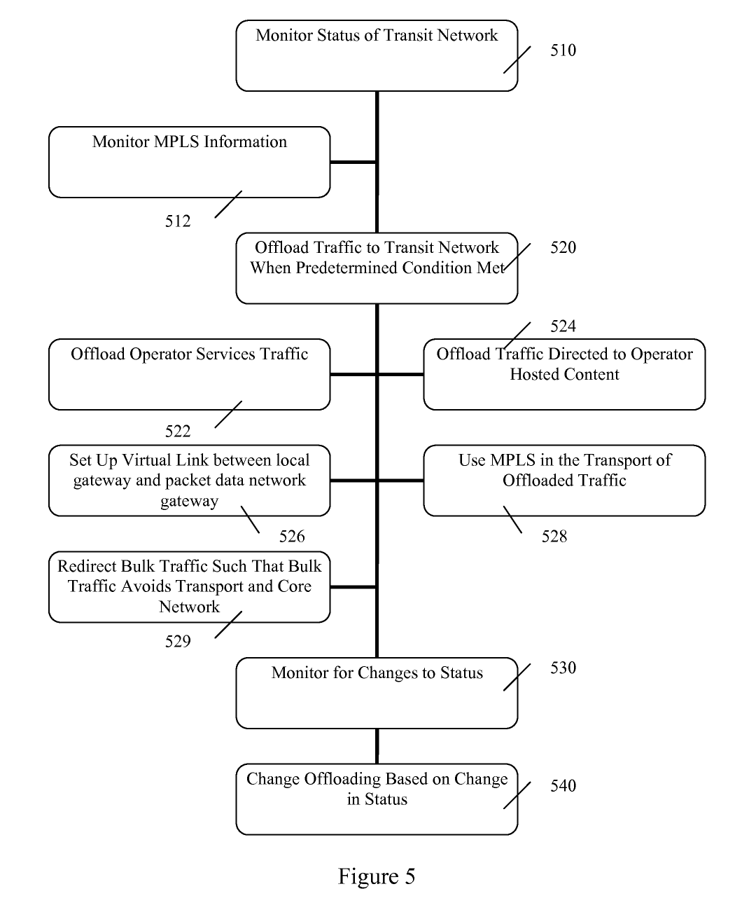

FIG. 5 illustrates a method according to certain embodiments of the present invention. As shown in FIG. 5, a method may include, at 510, monitoring a status of a transit network. Monitoring the status can include, at 512, monitoring multiprotocol label switching information.

The method can also include, at 520, offloading traffic to the transit network from a transport network when a predetermined condition is met. The predetermined condition can include the status of the transit network indicating that the transit network is operational.

The predetermined condition can moreover include that the status of the transit network indicating that the transit network is sufficiently reliable to provide a minimum quality of service. Thus, for example a threshold of reliability can use be used to determine whether the reliability of the transit network is capable of supporting best effort communications or even communications that have more demanding quality of service requirements.

The offloading traffic can include, at 522, offloading operator services traffic or, at 524, offloading traffic directed to operator hosted content. In other words, the offloading traffic does not have to be limited to offloading bulk traffic destined for the internet, but can also include traffic intended for the core network or other networks within an operator's control.

The offloading can also include, at 526, setting up a virtual link between a local gateway and a packet data network gateway. The offloading can further include, at 528, transporting the traffic over a virtual link using multiprotocol label switching or a virtual local area network. The offloading can additionally, include, at 529, redirecting bulk traffic so that the bulk traffic does not pass through the transport network or the core network. In other words, a device at the edge between the radio access network and the transport network can redirect bulk traffic via a transit network toward its final destination, which may be, for example, a web site on the Internet.

The method can additionally include, at 530, further monitoring for changes in the status of the transit network; and, at 540, changing the offloading based on a change in the status of the transit network.

The preceding method can be performed in a local gateway or a packet data network gateway. A computer readable medium, such as a non-transitory computer readable medium, can be encoded with instructions that, when performed in hardware, perform the preceding method.

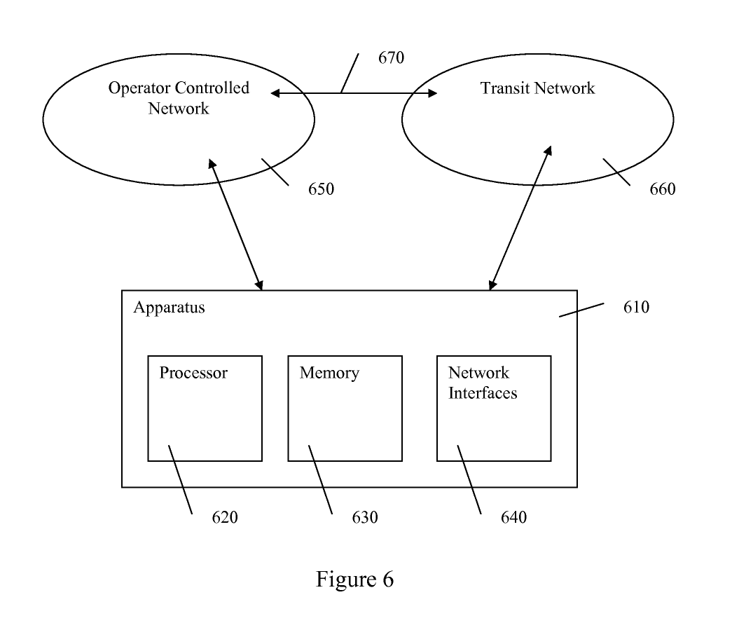

FIG. 6 illustrates a system according to certain embodiments of the present invention. As shown in FIG. 6, an apparatus 610, which may be a local gateway or a packet data network gateway, can include at least one processor 620, at least one memory 630 (which may include computer program instructions), and network interfaces 640. The network interfaces 640 may permit the apparatus 610 to communicate over an operator controlled network 650, such as a transport network. The network interfaces 640 may also permit the apparatus 610 to communicate over a transit network 660, which may not be operator controlled. The operator controlled network 650 and the transit network 660 may be configured to communicate with one another elsewhere, such as at another gateway, as illustrated by communication link 670.

The at least one processor 620 can be variously embodied by any computational or data processing device, such as a central processing unit (CPU) or application specific integrated circuit (ASIC). The at least one processor 620 can be implemented as one or a plurality of controllers.

The at least one memory 630 can be any suitable storage device, such as a non-transitory computer-readable medium. For example, a hard disk drive (HDD) or random access memory (RAM) can be used in the at least one memory 630. The at least one memory 630 can be on a same chip as the at least one processor 620, or may be separate from the at least one processor 620.

The computer program instructions may be any suitable form of computer program code. For example, the computer program instructions may be a compiled or interpreted computer program.

The at least one memory 630 and computer program instructions can be configured to, with the at least one processor 620, cause a hardware apparatus (for example, apparatus 610) to perform a process, such as the process shown in FIG. 5 or any other process described herein.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
monitoring a status of a transit network; and
offloading traffic to the transit network from a transport network when a predetermined condition is met,
wherein the predetermined condition comprises the status of the transit network indicating that the transit network is operational.

2. The method of claim 1, wherein the offloading the traffic is performed when the predetermined condition comprises the status of the transit network indicating that the transit network is sufficiently reliable to provide a minimum quality of service.

3. The method of claim 1, wherein the offloading traffic comprises offloading traffic having a best effort quality of service level.

4. The method of claim 1, wherein the offloading traffic comprises offloading operator services traffic.

5. The method of claim 1, wherein the offloading traffic comprises offloading traffic directed to operator hosted content.

6. The method of claim 1, wherein the offloading comprises setting up a virtual link between a local gateway and a packet data network gateway.

7. The method of claim 1, wherein the offloading comprises transporting the traffic over a virtual link using multiprotocol label switching or a virtual local area network.

8. The method of claim 1, wherein the method further comprises:
further monitoring for changes in the status of the transit network; and
changing the offloading based on a change in the status of the transit network.

9. The method of claim 1, wherein the offloading comprises redirecting bulk traffic so that the bulk traffic does not pass through the transport network or the core network.

10. The method of claim 1, wherein monitoring the status comprises monitoring multiprotocol label switching information.

11. An apparatus, comprising:
at least one memory comprising computer program instructions; and
at least one processor,
wherein the at least one memory and the computer program instructions are configured to, with the at least one processor, cause the apparatus at least to
monitor a status of a transit network, and
offload traffic to the transit network from a transport network when a predetermined condition is met,
wherein the predetermined condition comprises the status of the transit network indicating that the transit network is operational.

12. The apparatus of claim 11, wherein the at least one memory and the computer program instructions are configured to, with the at least one processor, cause the apparatus at least to offload the traffic when the predetermined condition comprises the status of the transit network indicating that the transit network is sufficiently reliable to provide a minimum quality of service.

13. The apparatus of claim 11 or claim 12, wherein the at least one memory and the computer program instructions are configured to, with the at least one processor, cause the apparatus at least to offload traffic having a best effort quality of service level.

14. The apparatus of claim 11, wherein the at least one memory and the computer program instructions are configured to, with the at least one processor, cause the apparatus at least to offload operator services traffic.

15. The apparatus of claim 11, wherein the at least one memory and the computer program instructions are configured to, with the at least one processor, cause the apparatus at least to offload traffic directed to operator hosted content.

16. The apparatus of claim 11, wherein the at least one memory and the computer program instructions are configured to, with the at least one processor, cause the apparatus at least to set up a virtual link between a local gateway and a packet data network gateway.

17. The apparatus of claim 11, wherein the at least one memory and the computer program instructions are configured to, with the at least one processor, cause the apparatus at least to transport the traffic over a virtual link using multiprotocol label switching or a virtual local area network.

18. The apparatus of claim 11, wherein the at least one memory and the computer program instructions are further configured to, with the at least one processor, cause the apparatus at least to
further monitor for changes in the status of the transit network; and
change offloading of the traffic based on a change in the status of the transit network.

19. The apparatus of claim 11, wherein the at least one memory and the computer program instructions are configured to, with the at least one processor, cause the apparatus at least to redirect bulk traffic so that the bulk traffic does not pass through the transport network or the core network.

20. The apparatus of claim 11, wherein the at least one memory and the computer program instructions are configured to, with the at least one processor, cause the apparatus at least to monitor multiprotocol label switching information.

21. An apparatus, comprising:
monitoring means for monitoring a status of a transit network; and
offloading means for offloading traffic to the transit network from a transport network when a predetermined condition is met,
wherein the predetermined condition comprises the status of the transit network indicating that the transit network is operational.

22. The apparatus of claim 21, wherein the offloading the traffic is performed when the predetermined condition comprises the status of the transit network indicating that the transit network is sufficiently reliable to provide a minimum quality of service.

23. The apparatus of claim 21, wherein the offloading traffic comprises offloading traffic having a best effort quality of service level.

24. The apparatus of claim 21, wherein the offloading traffic comprises offloading operator services traffic.

25. The apparatus of claim 21, wherein the offloading traffic comprises offloading traffic directed to operator hosted content.

26. The apparatus of claim 21, wherein the offloading comprises setting up a virtual link between a local gateway and a packet data network gateway.

27. The apparatus of claim 21, wherein the offloading comprises transporting the traffic over a virtual link using multiprotocol label switching or a virtual local area network.

28. The apparatus of claim 21, further comprising:
further monitoring means for monitoring for changes in the status of the transit network; and
updating means for changing the offloading based on a change in the status of the transit network.

29. The method of claim 21, wherein the offloading comprises redirecting bulk traffic so that the bulk traffic does not pass through the transport network or the core network.

30. The method of claim 21, wherein monitoring the status comprises monitoring multiprotocol label switching information.

31. A computer readable non-transitory medium encoded with a computer program containing instructions that, when executed in hardware, perform a process, the process the method according to claim 1.
